(19) United States
(12) Patent Application Publication
(10) Pub. No.: US 2014/0365128 A1
(43) Pub. Date: Dec. 11, 2014

(54) METHOD FOR PREDICTING HOURLY CLIMATIC DATA TO ESTIMATE COOLING/HEATING LOAD

(71) Applicant: GAGYOTECH CO., LTD., Daejeon (KR)

(72) Inventors: Seongyeon Yoo, Daejeon (KR); Hongik Yoon, Daejeon (KR); Kyuhyun Han, Daejeon (KR); Taeho Kim, Jeollabuk-do (KR)

(21) Appl. No.: 14/369,639

(22) PCT Filed: Oct. 30, 2012
(86) PCT No.: PCT/KR2012/009001

§ 371 Date: Jun. 27, 2014

(30) Foreign Application Priority Data
Dec. 29, 2011 (KR) 10-2011-0146439

(51) Int. Cl. G01W 1/10

(52) U.S. Cl. CPC G01W 1/10
USPC 702/3

(57) ABSTRACT

A method for predicting hourly climatic data to estimate cooling/heating load includes a climatic data acquiring step of acquiring past climatic data from meteorological offices, a climatic data analyzing and extracting step of extracting necessary data by analyzing the climatic data acquired in the climatic data acquiring step, a non-dimensional value calculating step of calculating non-dimensional values by non-dimensionalizing the climatic data extracted in the climatic data analyzing and extracting step, a correlation equation determining step of expressing a correlation from the non-dimensional values calculated in the non-dimensional value calculating step, and a next-day hourly climatic data predicting step of predicting hourly climatic data for the next day from the hourly non-dimensional values, which are obtained in the correlation equation determining step, wherein maximum and minimum relative humidity and the amount of insolation used in the next-day hourly climatic data predicting step are estimated using a fuzzy algorithm.

### TECHNICAL FIELD

The present invention relates to a method for predicting hourly climatic data to estimate a cooling/heating load, and more particularly, to a method for predicting hourly climatic data to estimate a cooling/heating load, which may accurately predict an hourly outdoor air temperature, relative humidity, an amount of solar radiation or the like used in calculating a cooling/heating load of a building by only using a maximum temperature and a minimum temperature provided by the Meteorological Office, thereby effectively and economically operating a cooling and heating system.

### BACKGROUND ART

In order to determine a capacity of the cooling and heating system at a design stage of a building, it is necessary to calculate a cooling/heating load of the building, and also at an operation stage of an air-conditioning system of the building, the estimation of the cooling/heating load is important in effectively and economically controlling the air-conditioning system based on energy consumption and cost necessary in the operation.

A heat load of a building is a calorific value which should be provided or removed to maintain an indoor space in a target environment. At this time, one of factors having the largest influence in calculating or estimating the heat load may be a climatic state of an area in which the building is located.

Therefore, in order to precisely estimate the heat load of the building, it is the most important to secure long-term and reliable climatic data. If the climatic data is inaccurate, reliability of calculated or estimated results of the heat load may be deteriorated.

The climatic data required when calculating the cooling/heating load to determine the capacity of the cooling and heating system at the initial design stage of the building is typical climatic data which may be generally made out based on long-range measured data and thus may represent climate of the corresponding area.

The typical climatic data has been developed and provided in various types, such as TRY, TMY, WYEC, TMY2 and WYEC2, according to a statistical treatment method and a data structure. In practice, the typical climatic data is used in an energy simulation of the building at the initial design stage of the building. The common property of the typical climatic data is that main meteorological elements shows consistent distribution similar to long-term distribution.

However, to estimate a next-day cooling/heating load and apply it to the operation of the cooling and heating system at the actual operation stage of the air-conditioning system of the building, unlike the initial design stage of the building, it is necessary to consider an operational scenario and uncertainty about an external environment. Therefore, in order to allow the load estimation, in which such characteristic is reflected, to be enabled, a different type of climatic data from the typical climatic data is required. That is to predict hourly climate data considering a change in the external environment while maintaining consistency and periodicity like in the typical climatic data is an essential factor in the prediction of the next-day cooling/heating load.

Thus, a plurality of methods of predicting the next-day cooling/heating load have been proposed. In most of the proposed methods, a next-day outdoor air temperature value is obtained through a meteorological forecast and then updated through a temperature correction factor in which a difference between the obtained value and an actually measured temperature value is reflected. However, there is a disadvantage in that an amount of insolation is not considered.

Therefore, the inventors had been proposed a method of predicting next-day hourly temperature and specific humidity using climatic data of the years issued from the Meteorological Office without actual measuring of the outdoor air temperature, which has been granted as U.S. Pat. No. 949,044 (entitled An optimal operation method of a cooling and heating system). This method has an advantage in that it is possible to precisely predict the next-day outdoor air temperature, compared with a conventional method, but also has some disadvantages in that prediction accuracy of relative humidity is slightly lowered, and the amount of solar radiation necessary in the calculation of the cooling/heating load is not reflected.

### DISCLOSURE

### Technical Problem

The present invention is directed to providing a method for predicting hourly climatic data to estimate a cooling/heating load, which may accurately predict an hourly outdoor air temperature, relative humidity and an amount of solar radiation (hereinafter, referred to as “the climatic data”) by only using a maximum temperature and a minimum temperature provided from the Meteorological Office without actual measuring of the climatic state such as the outdoor air temperature, and thus may more accurately estimate a next-day cooling/heating load.

### Technical Solution

One aspect of the present invention provides a method for predicting hourly climatic data to estimate a cooling /heating load, the Method including a climatic data acquiring process of acquiring past climatic data from a meteorological office; a climatic data analyzing and extracting process of extracting necessary data by analyzing the climatic data acquired in the climatic data acquiring process; a non-dimensional value calculating process of calculating non-dimensional values by normalizing the climatic data extracted in the climatic data analyzing and extracting process; a correlation equation determining process of expressing a correlation from the non-dimensional values calculated in the non-dimensional value calculating process; and a next-day hourly climatic data predicting process of predicting next-day hourly climatic data from the hourly non-dimensional values obtained in the correlation equation determining process, wherein maximum and minimum relative humidity and an amount of insolation used in the next-day hourly climatic data predicting process are estimated using a fuzzy algorithm.

Outdoor air temperature (T*), relative humidity (RH*) and an amount of solar radiation (I*) may be normalized.

The non-dimensional outdoor air temperature, the non-dimensional relative humidity and the non-dimensional amount of solar radiation may be respectively calculated by each correlation equation with respect to time.

### Advantageous Effects

The present invention can accurately predict the climatic data, such as the hourly outdoor air temperature, the relative humidity and the amount of solar radiation, by only using a maximum temperature and a minimum temperature provided from the Meteorological Office without the actual measuring of the outdoor air temperature and thus can accurately estimate the next-day cooling/heating load.

Further, the present invention can predict the maximum/minimum relative humidity and solar radiation by using a fuzzy algorithm, and thus can more precisely and rationally predict the hourly climatic data.

Furthermore, since the outdoor air temperature, the relative humidity and the amount of solar radiation are normalized and then used, the present invention is not affected by a range of the given climatic data, and thus not affected by the application object and place.

### DESCRIPTION OF DRAWINGS

FIG. 1 is a flow chart illustrating a method for predicting hourly climatic data according to the present invention.

FIG. 2 is a graph illustrating distribution of outdoor air temperature.

FIG. 3 is a graph illustrating distribution of relative humidity.

FIG. 4 is a graph illustrating distribution of solar radiation.

FIG. 5 is a graph illustrating a change in hourly non-dimensional outdoor air temperature for five years.

FIG. 6 is a graph illustrating a change in hourly non-dimensional relative humidity for five years.

FIG. 7 is a graph illustrating a change in hourly non-dimensional solar radiation for five years.

FIG. 8 is a graph comparing predicted outdoor air temperature and actually measured outdoor air temperature.

FIG. 9 is a graph comparing predicted relative humidity and actually measured relative humidity.

FIG. 10 is a graph comparing predicted amount of solar radiation and actually measured amount of solar radiation.

FIGS. 11 to 13 are graphs comparing the outdoor air temperature, the relative humidity and the amount of solar radiation predicted at the Daejeon area in July and August 2008 and the actually measured data from the Meteorological Office.

### MODES OF THE INVENTION

Hereinafter, exemplary embodiments of the present invention will be described in detail.

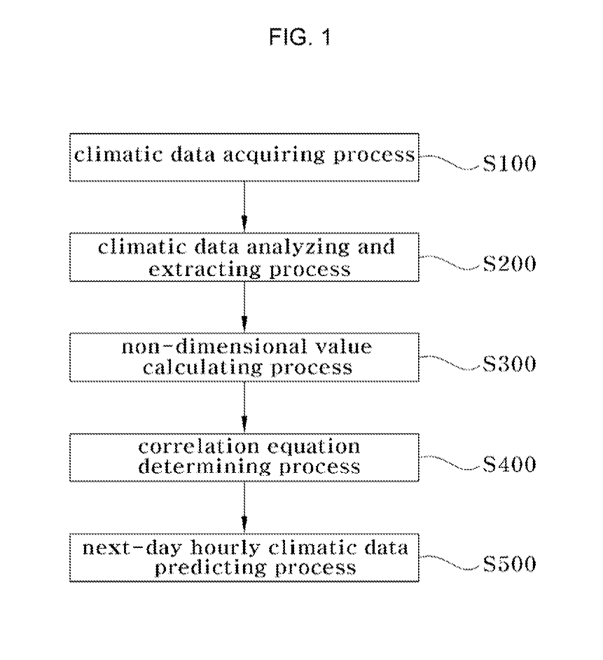

The present invention relates to a method for predicting hourly climatic data to estimate a cooling/heating load, which may precisely predict a next-day cooling/heating load by using only climatic data provided from the Meteorological Office without using real measured values. To this end, as illustrated in FIG. 1, the present invention includes a climatic data acquiring process S100, a climatic data analyzing and extracting process S200, a non-dimensional value calculating process S300, a correlation equation determining process S400 and a next-day hourly climatic data predicting process S500.

(1) The Climatic Data Acquiring Process S100

In this process, basic climatic data necessary to calculate the cooling/heating load is downloaded from the Meteorological Office via internet and stored in the memory of a controller(or a computer) of an automatic control system for a building.

The Meteorological Office records outdoor air temperature, relative humidity, an amount of solar radiation, a wind direction, a wind speed, or the like, which are measured in weather stations located over the country and provides these data to the public via internet. Here, the temperature and the relative humidity are hourly measured as instantaneous values. The temperature is indicated by ° C., the relative humidity is indicated by %, and the amount of solar radiation is measured every minute from sunrise to sunset, and values measured for one hour are added and indicated by J/m².

In the present invention, to analyze the outdoor air temperature, the relative humidity and the amount of solar radiation at the Daejeon area in June, July, August and September in which the cooling load is generated, the climatic data of five years from 2003 to 2007, which was measured by the Meteorological Office, was downloaded.

(2) The Climatic Data Analyzing and Extracting Process S200

In this process, the climatic data acquired in the climatic data acquiring process S100 is analyzed, and only the necessary climatic data is extracted from the memory of the controller.

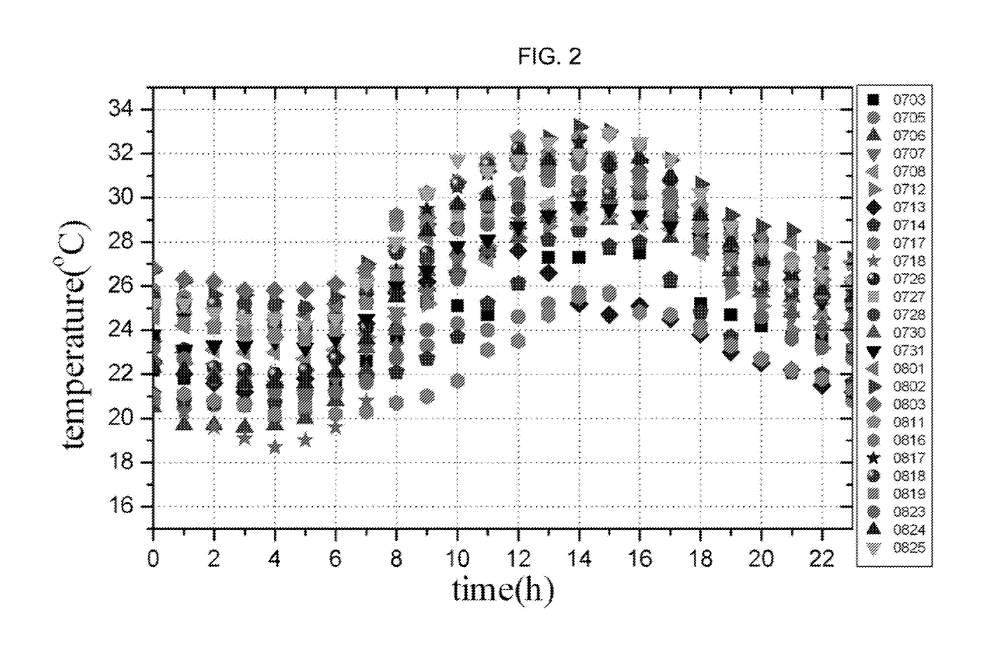

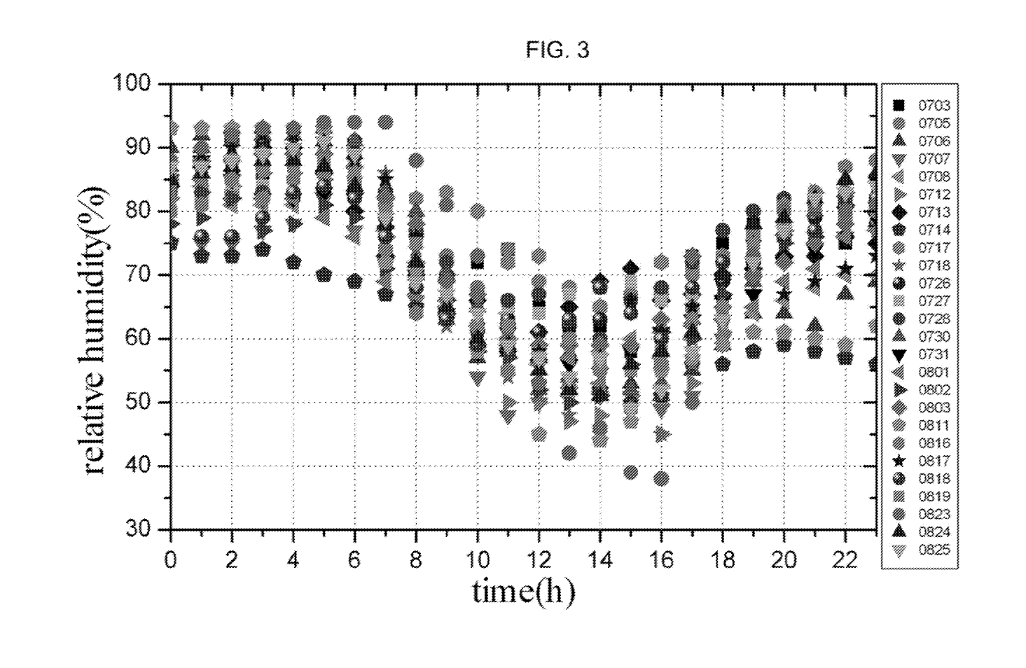

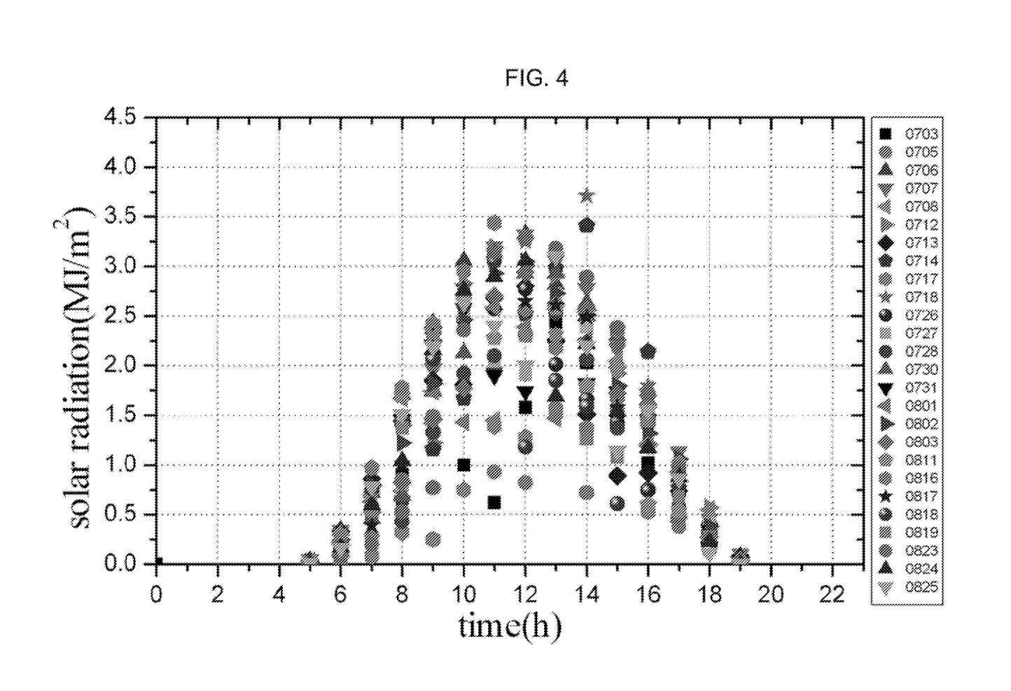

FIGS. 2 to 4 are graphs illustrating the outdoor air temperature, the relative humidity and the amount of solar radiation which are measured at the Daejeon area for two months of July and August 2007.

Referring to FIGS. 2 to 4, it may be understood that the outdoor air temperature is maximum between 13 o'clock and 15 o'clock, and minimum between 4 a.m. and 6 a.m. Further, it may be also understood that the outdoor air temperature is monotonically increased and decreased, and changed every day in a certain pattern.

In a change in the relative humidity with respect to the outdoor air temperature, it may be understood that, when the outdoor air temperature is high, the relative humidity is low, and when outdoor air temperature is low, the relative humidity is high.

The amount of solar radiation has a maximum value between 11 o'clock and 12 o'clock when the sunrise is at 4 a.m., and the sunset is at 19 o'clock.

As a result, it may be understood that the outdoor air temperature, the relative humidity and the amount of solar radiation has constant change patterns which are monotonically increased and decreased between maximum values and minimum values. Therefore, in the present invention, the climatic data of the outdoor air temperature, the relative humidity and the amount of solar radiation is predicted by using such characteristics.

(3) The Non-Dimensional Value Calculating Process S300

In this process, non-dimensional values of the outdoor air temperature, the relative humidity and the amount of solar radiation are calculated to predict the outdoor air temperature, the relative humidity and the amount of solar radiation in the controller. To this end, the hourly outdoor air temperature, relative humidity and amount of solar radiation for one day are normalized.

\textcircled{1} Non-Dimensional Outdoor Air Temperature T*

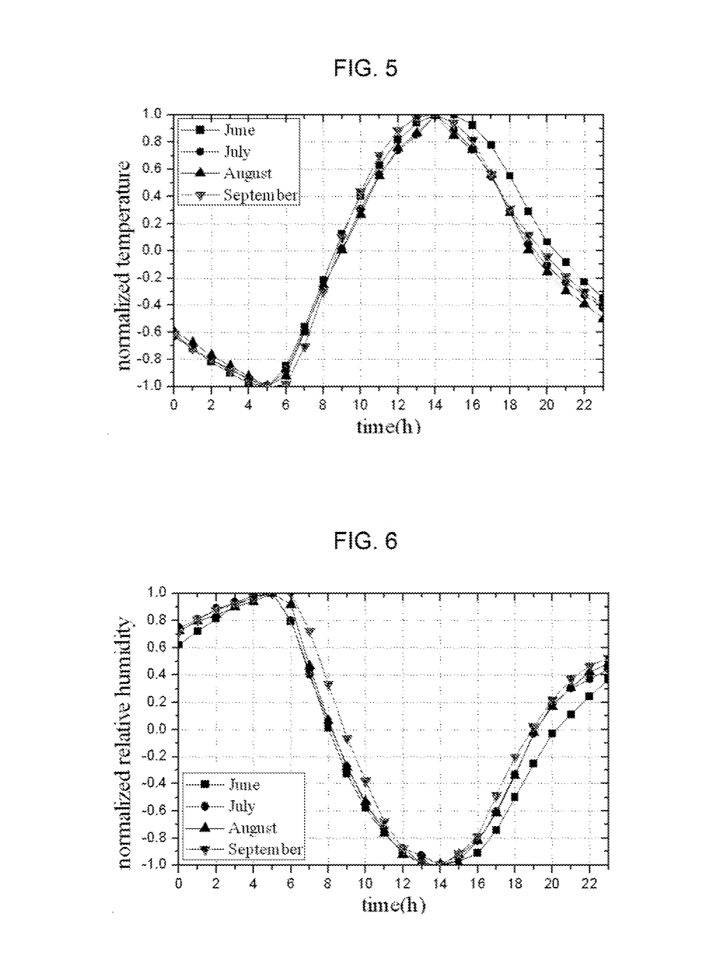

Firstly, a method of calculating the non-dimensional outdoor air temperature will be described. The hourly outdoor air temperature for one day in each month is substituted into Equation 1 and normalized. Thus, a graph as illustrated in FIG. 5 may be obtained. At this time, the maximum temperature is 1, and the minimum temperature is −1, and the rest temperatures have the non-dimensional values within a range of +1 to −1.

FIG. 5 is a graph illustrating a result of calculating the non-dimensional outdoor air temperature T* at the Daejeon area in June to September from 2003 to 2007 using Equation 1.

$${T}^{*} = \frac{T ( h ) - {T}_{avg}}{{T}_{max} - {T}_{avg}} , - 1 \leq {T}^{*} \leq 1 \qquad [ Equation 1 ]$$

wherein T* is the non-dimensional outdoor air temperature, T(h) is the hourly outdoor air temperature, Tₘₐₓ is the maximum temperature of the day, and T_{avg} is an arithmetic average temperature of the maximum temperature and the minimum temperature.

\textcircled{2} Non-Dimensional Relative Humidity RH*

Like in predicting the temperature, to predict the relative humidity, the hourly relative humidity for one day is normalized by Equation 2, and thus the non-dimensional relative humidity RH* is obtained.

FIG. 6 is a graph illustrating a result of calculating the non-dimensional relative humidity RH* at the Daejeon area in June to September from 2003 to 2007 using Equation 2.

$${RH}^{*} = \frac{RH ( h ) - {RH}_{avg}}{{RH}_{max} - {RH}_{avg}} , - 1 \leq {RH}^{*} \leq 1 \qquad [ Equation 2 ]$$

wherein RH* is the non-dimensional relative humidity, RH(h) is the hourly relative humidity, RHₘₐₓ is the maximum relative humidity of the day, and RH_{avg} an arithmetic average relative humidity of the maximum relative humidity and the minimum relative humidity.

\textcircled{3} Non-Dimensional Amount of Solar Radiation I*

In the same manner, to predict the amount of solar radiation, the hourly amount of solar radiation for one day is normalized by Equation 3, and thus the non-dimensional amount of solar radiation I* is obtained.

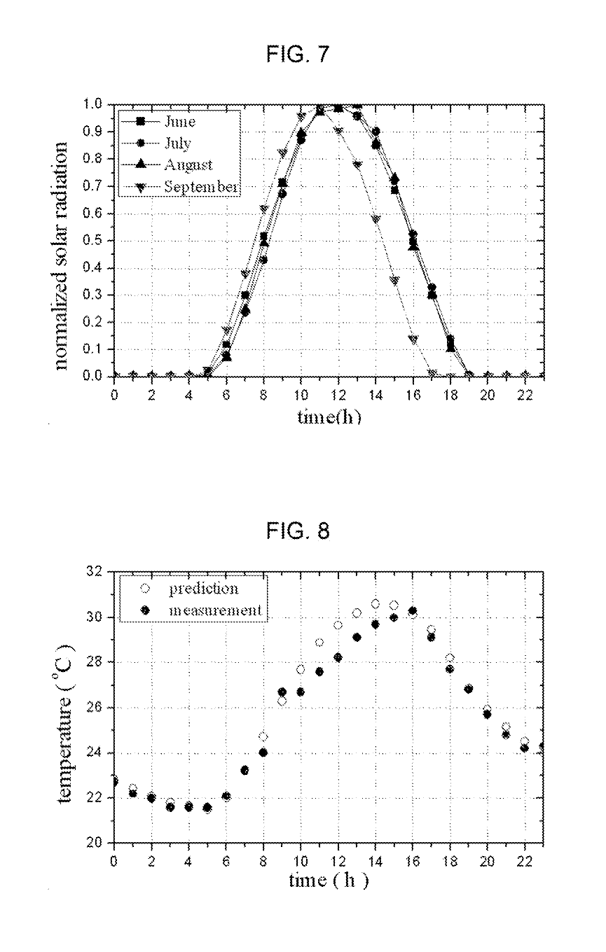

FIG. 7 is a graph illustrating a result of calculating the non-dimensional amount of solar radiation I* at the Daejeon area in June to September from 2003 to 2007 using Equation 2.

$${I}^{*} = \frac{I ( h )}{{I}_{max}} , 0 \leq {I}^{*} \leq 1 \qquad [ Equation 3 ]$$

wherein I* is the non-dimensional amount of solar radiation, I(h) is the hourly amount of solar radiation, and Iₘₐₓ is the maximum hourly accumulated amount of solar radiation of the day.

(4) The Correlation Equation Determining Process S400

In this process, a correlation equation between time and the non-dimensional values is acquired from the hourly non-dimensional values obtained in the non-dimensional value calculating process S300, and a correlation therebetween is determined in the controller.

As illustrated in FIGS. 5 to 7, monthly non-dimensional value curves of the outdoor air temperature and the relative humidity have the constant pattern according to the time in all of June, July, August and September. The amount of solar radiation has the same sunrise time in all of the months, which is 5 o'clock, and also has the constant pattern according to the time. However, in case of the distribution of solar radiation in September, the values thereof after 11 o'clock are biased to go forward by 2 o'clock, compared with other months.

Therefore the present invention uses the correlation between the time and the non-dimensional outdoor air temperature, relative humidity and amount of solar radiation. To this end, each correlation of the non-dimensional outdoor air temperature T*, the non-dimensional relative humidity RH* with respect to the time is calculated using Equations 4 to 6.

$${T}^{*} = {\sum }_{i = 0}^{6} {B}_{i} {h}^{i} \qquad [ Equation 4 ]$$

wherein T* is the non-dimensional outdoor air temperature, B is a correlation coefficient, and h is time.

$${RH}^{*} = {\sum }_{i = 0}^{6} {B}_{i} {h}^{i} \qquad [ Equation 5 ]$$

wherein RH* is the non-dimensional relative humidity, B is a correlation coefficient, and h is time.

$${I}^{*} = {\sum }_{i = 0}^{6} {B}_{i} {h}^{i} \qquad [ Equation 6 ]$$

wherein I* is the non-dimensional amount of solar radiation, B is a correlation coefficient, and h is time.

Each correlation equation generated by Equations 4 to 6 is calculated in a sixth-degree polynomial expression, and the correlation coefficients B indicated in Tables 1 to 3 were acquired for each correlation equation from June to September at the Daejeon area for five years which are from 2003 to 2007. In the same manner, the correlation coefficients for each correlation equation from January to December may be acquired.

Table 1 indicates the correlation coefficients with respect to the outdoor air temperature, Table 2 indicates the correlation coefficients with respect to the relative humidity, and Table 3 indicates the correlation coefficients with respect to the amount of solar radiation.

TABLE 1

| | June | July | August | September |
|---|---|---|---|---|
| B₀ | −0.62 | −0.66 | −0.62 | −0.65 |
| B₁ | −0.00582 | 0.1018 | 0.11 | 0.18 |
| B₂ | −0.096 | −0.14 | −0.15 | −0.2 |
| B₃ | 0.027 | 0.033 | 0.035 | −0.45 |
| B₄ | −0.0023 | −0.002 | −0.003 | −0.0039 |
| B₅ | 8.29E−5 | 1.0E−4 | 1.03E−4 | 1.4E−4 |
| B₆ | 1.6E−7 | −1.29E−6 | −1.33E−6 | −1.86E−6 |

TABLE 2

| | June | July | August | September |
|---|---|---|---|---|
| B₀ | 0.6045 | 0.74028 | 0.735 | 0.76831 |
| B₁ | 0.0548 | −0.0073 | −0.08855 | −0.21334 |
| B₂ | 0.0813 | 0.09098 | 0.13419 | 0.19735 |
| B₃ | −0.026 | −0.02656 | −0.03419 | −0.4399 |
| B₄ | 0.0024 | 0.00239 | 0.00299 | 0.00366 |
| B₅ | −9.27E−5 | −8.71E−5 | −1.09E−4 | −1.30E−4 |
| B₆ | 1.252E−6 | 1.131E−6 | 1.437E−6 | 1.682E−6 |

TABLE 3

| | June | July | August | September |
|---|---|---|---|---|
| B₀ | −0.02673 | −0.03755 | −0.03447 | −0.00429 |
| B₁ | 0.18488 | 0.2269 | 0.22167 | 0.12743 |
| B₂ | −0.13492 | −0.15505 | −0.15539 | −0.11915 |
| B₃ | 0.03178 | 0.03475 | 0.03542 | 0.03229 |
| B₄ | −0.00289 | −0.00307 | −0.00317 | −0.00322 |
| B₅ | 1.12E−4 | 1.0E−4 | 1.2E−4 | 1.35E−4 |
| B₆ | −1.57E−6 | −1.63E−6 | −1.72E−6 | −2.02E−6 |

(5) The Next-Day Hourly Climatic Data Predicting Process S500

In this process, the hourly non-dimensional values acquired in the correlation equation determining process S400 is substituted into Equations 7 to 9, and each change in the next-day hourly outdoor air temperature, relative humidity and amount of solar radiation is predicted in the controller.

Tₑₛ=T_{avg}+T*(Tₘₐₓ−T_{avg)} [Equation 7]

wherein Tₑₛ is predicted next-day outdoor air temperature, T* is the non-dimensional outdoor air temperature calculated by the correlation equation (Equation 4), and Tₘₐₓ and T_{avg} are next-day maximum temperature and an next-day average temperature.

RHₑₛ=RH_{avg}+RH*(RHₘₐₓ−RH_{avg}) [Equation 8]

wherein RHₑₛ is predicted next-day relative humidity, RH* is the non-dimensional relative humidity calculated by the correlation equation (Equation 5), and RHₘₐₓ and RH_{avg} a next-day maximum relative humidity and an next-day average relative humidity.

Iₑₛ=I_{avg}+I*(Iₘₐₓ−I_{avg}) [Equation 9]

wherein Iₑₛ is predicted next-day amount of solar radiation, I* is the non-dimensional amount of solar radiation calculated by the correlation equation (Equation 6), and Iₘₐₓ and I_{avg} are next-day maximum amount of solar radiation and an next-day average amount of solar radiation.

(6) The Maximum and Minimum Values Predicting Process

In this process, the maximum relative humidity, the minimum relative humidity, the maximum amount of solar radiation and the minimum amount of solar radiation which are necessary to use the prediction equations of Equations 7 to 9 in the next-day hourly climatic data predicting process S500 are predicted in the controller.

To predict the next-day hourly outdoor air temperature, relative humidity and amount of solar radiation using Equations 7 to 9, it is necessary to acquire the Tₘₐₓ, RHₘₐₓ, Iₘₐₓ, T_{avg}, RH_{avg} and I_{avg}. Among them, the maximum outdoor air temperature and the minimum outdoor air temperature may be easily obtained from the weather forecast of the Meteorological Office, but the maximum relative humidity, the minimum relative humidity, the maximum amount of solar radiation and the minimum amount of solar radiation may not be obtained amid thus should be predicted.

To this end, in the present invention, uncertain properties among the temperature, the cloud cover and the relative humidity and among the temperature, the cloud cover and the amount of solar radiation, such as facts that “when the temperature is high and the cloud cover is increased, the relative humidity becomes lower”, and “when the temperature is high and the cloud cover is reduced, the amount of solar radiation becomes higher”, are applied to a fuzzy algorithm, and the maximum and minimum values of the relative humidity and the amount of solar radiation are predicted.

The maximum temperature, the minimum temperature and the cloud Cover are used as input variables of the fuzzy algorithm used in predicting the maximum and minimum values of the relative humidity and the amount of solar radiation. Here, the cloud cover may be fuzzy-quantifiable through the weather forecast of the Meteorological Office. In the present invention, “generally fair” in the weather forecast is quantifiable with a value of 0 to 2.5, “slightly covered sky” is quantifiable with a value of 2.5 to 5, “very cloudy sky” is quantifiable with a value of 5 to 7.5, and “generally cloudy” is quantifiable with a value of 7.5 to 10.

To apply the fuzzy algorithm, membership with respect to output variables uses values indicated in Table 4 and Table 5, a Min-Max method is used as an prediction method, and a centroid method is used as a defuzzification method. Since the Min-Max method and the centroid method are already well known, the detailed description thereof will be omitted.

Table 4 indicates the membership for acquiring the relative humidity, and Table 5 indicates the membership for acquiring the amount of solar radiation.

TABLE 4

| | Tₘₐₓ | | | | |
|---|---|---|---|---|---|
| RHₘₐₓ/Iₘᵢₙ | LL | L | M | H | HH |

| | | | | | | |
|---|---|---|---|---|---|---|
| cloud | HH | HH | H | H | L | L |
| | H | H | H | M | L | L |
| | L | H | H | M | L | L |
| | LL | H | H | L | L | LL |

TABLE 5

| | Tₘₐₓ | | | | |
|---|---|---|---|---|---|
| Iₘₐₓ/RHₘᵢₙ | LL | L | M | H | HH |

| | | | | | | |
|---|---|---|---|---|---|---|
| cloud | HH | LL | L | L | H | H |
| | H | L | L | M | H | H |
| | L | L | L | M | H | H |
| | LL | L | L | H | H | HH |

To verify the accuracy of the method for predicting the next-day outdoor air temperature, relative humidity and amount of solar radiation according to the present invention, as described above, the inventors had compared the next-day hourly values calculated by the present invention with actual values measured from the Meteorological Office.

FIG. 8 is a graph illustrating the results of comparing the hourly predicted outdoor air temperature calculated through Equation 7 at the Daejeon area on Jul. 30, 2008 with the actually outdoor air temperature measured from the Meteorological Office. It may be understood that the predicted outdoor air according to the present invention coincides with the actually outdoor air temperature measured from the Meteorological Office.

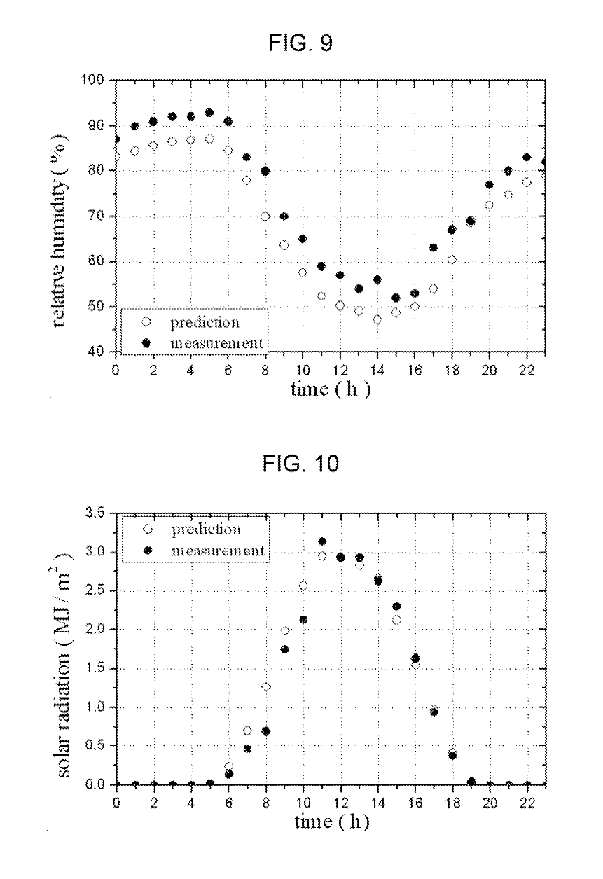

FIG. 9 is a graph illustrating the results of comparing the hourly predicted relative humidity calculated through Equation 8 at the Daejeon area on Jul. 30, 2008 with the actually relative humidity measured from the Meteorological Office. From this graph, it may be understood that a hourly distribution pattern of the predicted value exactly coincides with a hourly distribution pattern of the actually measured value. However, the distribution of the predicted relative humidity is less by about 5% than that of the actually measured relative humidity. It is determined that this is because the value predicted in a process of predicting the maximum and minimum relative humidity through the fuzzy algorithm is predicted to be lower than the actually measured value, and thus the whole predicted result is lower than the actually measured result. This error may be overcome through adjustment of a member function of the fuzzy algorithm.

FIG. 10 is a graph illustrating the results of comparing the hourly predicted amount of solar radiation calculated through Equation 8 at the Daejeon area on Jul. 30, 2008 with the actually measured and hourly accumulated amount of solar radiation measured from the Meteorological Office.

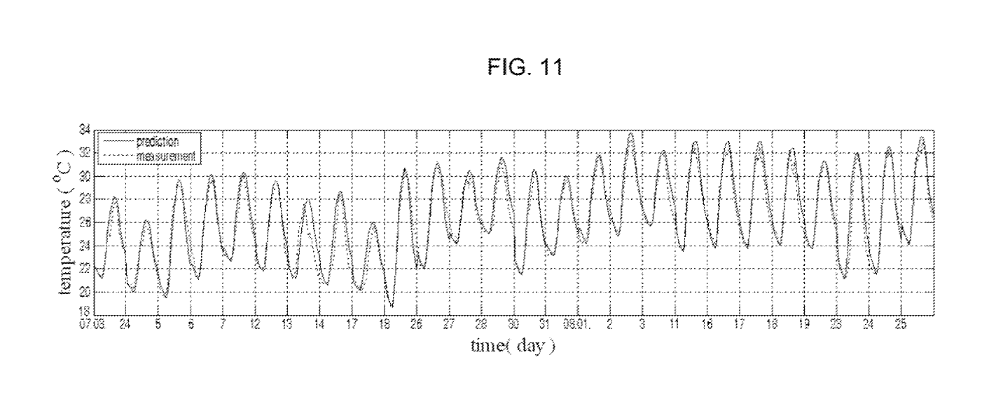

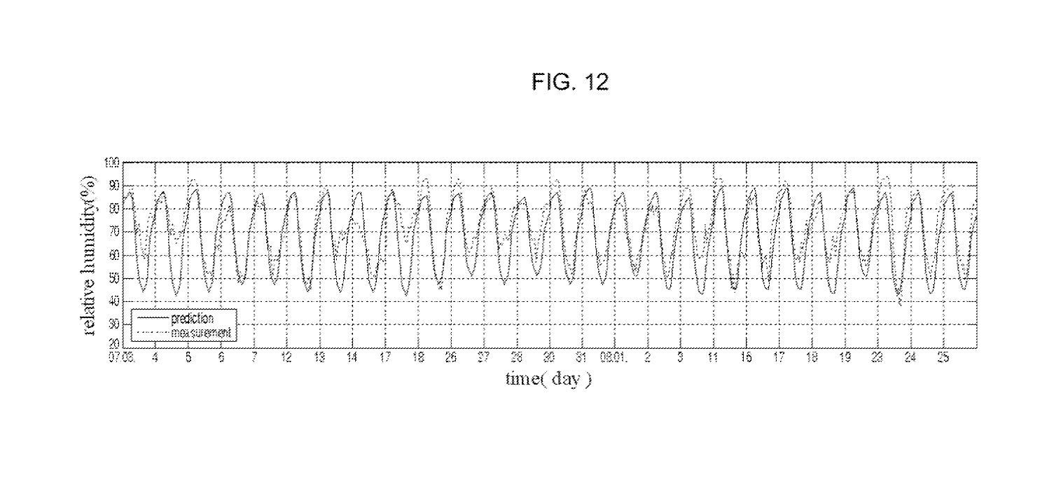

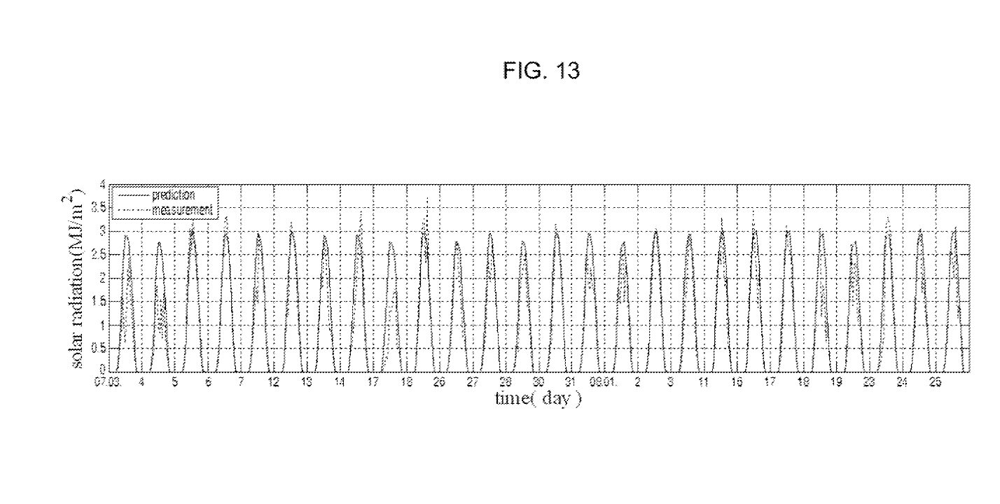

Further, FIGS. 11 to 13 are graphs respectively illustrating the results of comparing the outdoor air temperature, relative humidity and amount of solar radiation predicted at the Daejeon area for two months of July and August 2008 with the actually amount of solar radiation measured from the Meteorological Office. From this graph, it may be understood that the value predicted from the graph coincides with the actually measured value.

As described above, the present invention may accurately predict then hourly outdoor air temperature, relative humidity and amount of solar radiation by only using the maximum temperature and the minimum temperature provided from the Meteorological Office without using the actual measured value, and thus may more accurately estimate a next-da cooling/heating load.

1. A method for predicting hourly climatic data to estimate a cooling/heating load, the method comprising:
a climatic data acquiring process of acquiring past climatic data from a meteorological office;
a climatic data analyzing and extracting process of extracting necessary data by analyzing the climatic data acquired in the climatic data acquiring process in a controller;
a non-dimensional value calculating process of calculating non-dimensional values by normalizing the climatic data extracted in the climatic data analyzing and extracting process in the controller;
a correlation equation determining process of expressing a correlation from the non-dimensional values calculated in the non-dimensional value calculating process in the controller; and
a next-day hourly climatic data predicting process of predicting next-day hourly climatic data from the hourly non-dimensional values obtained in the correlation equation determining process in the controller,
wherein maximum and minimum relative humidity and an amount of solar radiation used in the next-day hourly climatic data predicting process are estimated using a fuzzy algorithm.

2. The relay method of claim 1, wherein the non-dimensional values calculated in the non-dimensional value calculating process are non-dimensional outdoor air temperature (T*), non-dimensional relative humidity (RH*) and non-dimensional amount of solar radiation (I*) which are respectively acquired by Equations 1 to 3, as follows:
$${T}^{*} = \frac{T ( h ) - {T}_{avg}}{{T}_{max} - {T}_{avg}} , - 1 \leq {T}^{*} \leq 1 \qquad [ Equation 1 ]$$
wherein T* is the non-dimensional outdoor air temperature, T(h) is hourly outdoor air temperature, Tₘₐₓ is maximum temperature of the day, and T_{avg} is an arithmetic average temperature of maximum temperature and the minimum temperature,
$${RH}^{*} = \frac{RH ( h ) - {RH}_{avg}}{{RH}_{max} - {RH}_{avg}} , - 1 \leq {RH}^{*} \leq 1 \qquad [ Equation 2 ]$$
wherein RH* is the non-dimensional relative humidity, RH(h) is hourly relative humidity, RHₘₐₓ is maximum relative humidity of the day, and RH_{avg} is an arithmetic average relative humidity of maximum relative humidity and minimum relative humidity, and
$${I}^{*} = \frac{I ( h )}{{I}_{max}} , 0 \leq {I}^{*} \leq 1 \qquad [ Equation 3 ]$$
wherein I* is the non-dimensional amount of solar radiation, I(h) is hourly amount of solar radiation, and Iₘₐₓ is maximum hourly accumulated amount of solar radiation of the day.

3. The relay method of claim 2, wherein a correlation equation for the non-dimensional outdoor air temperature (T*), non-dimensional relative humidity (RH*) and non-dimensional amount of solar radiation (I*) which are used in the correlation equation determining process uses Equations 4 to 6, as follows:
$${T}^{*} = {\sum }_{i = 0}^{6} {B}_{i} {h}^{i} \qquad [ Equation 4 ]$$
wherein T* is the non-dimensional outdoor air temperature, B is a correlation coefficient, and h is time,
$${RH}^{*} = {\sum }_{i = 0}^{6} {B}_{i} {h}^{i} \qquad [ Equation 5 ]$$
wherein RH* is the non-dimensional relative humidity, B is a correlation coefficient, and h is time, and
$${I}^{*} = {\sum }_{i = 0}^{6} {B}_{i} {h}^{i} \qquad [ Equation 6 ]$$
wherein I* is the non-dimensional amount of solar radiation, B is a correlation coefficient, and h is time.
